(19) United States
(12) Patent Application Publication
(10) Pub. No.: US 2010/0299948 A1
(43) Pub. Date: Dec. 2, 2010

(54) TAPE MEASURE

(75) Inventor: Kyoung-Soo Choi, Gyeonggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: INVENCO INC., Seoul (KR)

(21) Appl. No.: 12/682,165

(22) PCT Filed: Oct. 9, 2008
(86) PCT No.: PCT/KR08/05953

§ 371 Date: Jun. 10, 2010

(30) Foreign Application Priority Data
Oct. 9, 2007 (KR) 10-2007-0101618
Oct. 9, 2007 (KR) 10-2007-0101619
Oct. 9, 2007 (KR) 10-2007-0101620

(51) Int. Cl. G01B 3/10

(52) U.S. Cl. 33/768

(57) ABSTRACT

A tape measure is provided capable of controlling the retracting movement and speed of a tape with a friction force. The tape measure includes a case, a reel, a spiral spring, a tape, a pivot member, a friction member and a resilient member. The reel is rotatably retained within the case. The spiral spring resiliently urges the reel to rotate in a rewinding direction. The pivot member is pivotally mounted within the case. The friction member is operably coupled to the pivot member and makes contact with the tape wound on the outer circumference of the reel, thereby applying a friction force to the tape. The resilient member resiliently biases the pivot member to rotate in such a direction as to bring the friction member into contact with the tape.

### FIELD OF THE INVENTION

The present invention relates to a tape measure and, more particularly, to a tape measure capable of controlling the retracting movement and speed of a tape with a friction force.

### BACKGROUND ART

In general, a tape measure is widely used for length measurement purposes. The tape measure often employs a steel tape or a stainless steel tape to assure increased accuracy and precision in measurement. A typical tape measure includes a reel rotatably retained in a case, the reel having a tape wound thereon in a predetermined thickness. A spiral spring for elastically biasing the reel to rotate in tape-winding direction is installed at the center of the reel. Attached to the leading end of the tape drawn out of the opening of the case is a hook that can be removably fixed to an object to be measured.

As a user holding the case moves straightly away from the object in a state that the hook is fixed to the object, the tape is unwound from the reel and extended through the opening of the case. While the tape is unwound from the reel, the spiral spring is also coiled into a smaller diameter to store elastic energy therein. When the hook is detached from the object at the end of measurement, the spiral spring is uncoiled by the accumulated elastic restoration force thereof, thereby rotating the reel in a tape-winding direction to automatically rewind the tape on the outer circumference of the reel. If the hook strikes against the opening of the case and if the reel stops its rotation, the tape is completely received within the case.

U.S. Pat. Nos. 6,467,182 and 6,490,809 disclose a tape measure that employs a brake device for controlling the rewinding operation of a steel tape. If a brake is activated by manipulating a knob that protrudes out of a case, the brake makes contact with the steel tape to restrain the rewinding operation of the reel.

However, the tape measures disclosed in the above patents appear to have the following drawbacks. Since the tape is fast rewound by the elastic restoration force of the spiral spring, the hook is also retracted at a high speed and strikes the case with an increased force, thereby damaging the case or deforming the hook itself. Particularly, there is a possibility that the user may be injured if the user's hand or finger is in contact with the edge of the fast-rewinding steel tape or hit by the hook. Further, it is inconvenient and quite onerous to repeatedly stop or resume the rewinding operation of the tape by way of repetitive activation or release of the brake device in order to control the retracting speed of the steel tape.

### DETAILED DESCRIPTION OF THE INVENTION

### Technical Problems

In view of the above-noted drawbacks and other problems inherent in the prior art, it is an object of the present invention to provide a tape measure capable of controlling the retracting movement and speed of a tape with a friction force.

Another object of the present invention is to provide a tape measure that can assure smooth rewinding operation of a tape, while controlling the retracting movement and speed of a tape.

A further object of the present invention is to provide a tape measure capable of enhancing the safety through the use of a self-locking mechanism that can automatically stops the rewinding operation.

A still further object of the present invention is to provide a tape measure that enables a user to easily release the stoppage of a rewinding operation, consequently improving the convenience in use.

### Solution to the Technical Problems

In accordance with the present invention, there is provided a tape measure, comprising: a case having an opening at one side; a reel rotatably mounted within the case, the reel having an outer circumference; a spiral spring for elastically biasing the reel to rotate in a rewinding direction, the spiral spring having a first end fixedly secured to the case and a second end fixedly coupled to the reel; a tape wound on the outer circumference of the reel, the tape having a proximal end fixedly secured to the outer circumference of the reel and a distal end exposed through of the opening of the case, the tape having a maximum winding diameter in a fully retracted initial position; a pivot member pivotally mounted with the case; a friction member carried by the pivot member for making contact with the tape to apply a friction force to the tape when the tape is in the initial position; and a resilient member retained in the case for elastically biasing the pivot member to rotate in such a direction as to cause the friction member to make contact with the tape.

### BRIEF DESCRIPTION OF THE DRAWINGS

FIG. 1 is a perspective view showing a tape measure in accordance with a first embodiment of the present invention.

FIG. 2 is an exploded perspective view illustrating the tape measure in accordance with the first embodiment of the present invention.

FIG. 3 is a front view showing the interior of the tape measure in accordance with the first embodiment of the present invention, wherein a first case body is detached from a second case body.

FIG. 4 is a partially cut-away sectional view illustrating the tape measure in accordance with the first embodiment of the present invention, wherein a tape is in close contact with a friction member.

FIG. 5 is a partially cut-away sectional view illustrating the tape measure in accordance with the first embodiment of the present invention, wherein the tape is drawn out into a first position where the tape continues to make contact with the friction member.

FIG. 6 is a view similar to FIG. 5, but depicting that the tape is drawn out into a second position where the tape is separated from the friction member.

FIG. 7 is a perspective view showing a tape measure in accordance with a second embodiment of the present invention.

FIG. 8 is an exploded perspective view illustrating the tape measure in accordance with the second embodiment of the present invention.

FIG. 9 is a front view showing the interior of the tape measure in accordance with the second embodiment of the present invention, wherein a first case body is detached from a second case body.

FIG. 10 is a partially cut-away sectional view illustrating the tape measure in accordance with the second embodiment of the present invention, wherein a tape is in close contact with a friction member.

FIG. 11 is a partially cut-away sectional view illustrating the tape measure in accordance with the second embodiment of the present invention, wherein the tape is drawn out into a first position where the tape continues to make contact with the friction member.

FIG. 12 is a view similar to FIG. 11, but depicting that the tape is drawn out into a second position where the tape is separated from the friction member.

FIG. 13 is a perspective view showing a tape measure in accordance with a third embodiment of the present invention.

FIG. 14 is a front view showing the interior of the tape measure in accordance with the third embodiment of the present invention, wherein a first case body is detached from a second case body.

FIG. 15 is a partially cut-away sectional view illustrating the tape measure in accordance with the third embodiment of the present invention, wherein a tape is in close contact with a friction member.

FIG. 16 is a partially cut-away sectional view illustrating the tape measure in accordance with the third embodiment of the present invention, wherein the tape is drawn out into a first position where the tape continues to make contact with the friction member.

FIG. 17 is a view similar to FIG. 16, but depicting that the tape is drawn out into a second position where the tape is separated from the friction member.

FIG. 18 is a partially cut-away sectional view illustrating the operation of a manipulating mechanism in the tape measure in accordance with the third embodiment of the present invention.

FIG. 19 is a perspective view showing a tape measure in accordance with a fourth embodiment of the present invention.

FIG. 20 is an exploded perspective view showing the tape measure in accordance with the fourth embodiment of the present invention.

FIG. 21 is a front view showing the interior of the tape measure in accordance with the fourth embodiment of the present invention, wherein a first case body is detached from a second case body.

FIG. 22 is a partially cut-away sectional view illustrating a pivot member and a friction roller employed in the tape measure in accordance with the fourth embodiment of the present invention.

FIG. 23 is an exploded perspective view showing the pivot member and the friction roller employed in the tape measure in accordance with the fourth embodiment of the present invention.

FIG. 24 is a partially cut-away sectional view illustrating the tape measure in accordance with the fourth embodiment of the present invention, wherein a tape is in close contact with a friction member.

FIG. 25 is a partially cut-away sectional view illustrating the tape measure in accordance with the fourth embodiment of the present invention, wherein the tape is drawn out into a first position where the tape continues to makes contact with the friction member.

FIG. 26 is a view similar to FIG. 25, but depicting that the tape is drawn out into a second position where the tape is separated from the friction member.

FIG. 27 is a partially cut-away sectional view illustrating the operation of a button of the tape measure in accordance with the fourth embodiment of the present invention.

### BEST MODE FOR CARRYING OUT THE INVENTION

The other objects, features, advantages of the invention will become apparent from a review of the following detailed description of the preferred embodiment taken in conjunction with the accompanying drawings.

Hereinafter, a tape measure in accordance with preferred embodiments of the present invention will be described in detail with reference to the accompanying drawings.

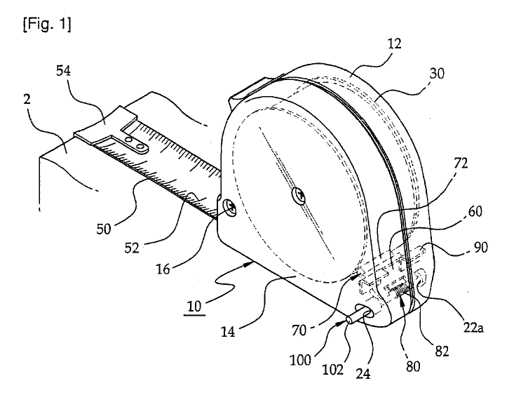

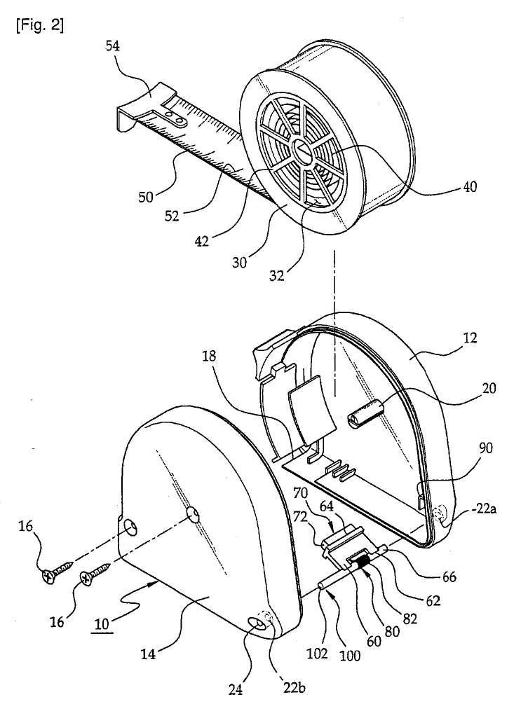

FIGS. 1 through 6 show a tape measure in accordance with a first embodiment of the present invention. Referring to FIGS. 1 and 2, the tape measure in accordance with the first embodiment of the present invention is provided with a case 10 generally defining the outer appearance of the tape measure. The case 10 includes a first case body 12 and a second case body 14 detachably joined to the first case body 12. The first case body 12 is coupled with the second case body 14 by screws 16 or the like. An opening 18 is provided in a lower front portion of the case 10. A boss 20 is formed at the center of an inner surface of the first case body 12. A pair of axial holes 22a and 22b is correspondingly formed on the opposite inner sides of the first and second case bodies 12 and 14. A through hole 24 communicating with the axial hole 22b is coaxially provided near the axial hole 22b in the second case body 14. In the alternative, the through hole 24 may be formed in the first case body 12 to communicate with the axial hole 22a of the first case body 12.

Referring to FIGS. 1 through 3, it will be seen that a reel 30 is rotatably retained within the case 10. A bore 32 for receiving the boss 20 of the case 10 is provided at the center of the reel 30. A spiral spring 40 for applying an elastic restoration force to the reel 30 is installed within an internal space 32A of the reel 30. A first end of the spiral spring 40 is fixedly secured to the boss 20 of the case 10, while a second end of the spiral spring 40 is fixedly coupled onto an inner surface of the reel 30. A cover 42 is provided at one side of the reel 30 to prevent the spiral spring 40 from being inadvertently removed from the internal space 32A of the reel 30. The elastic restoration force of the spiral spring 40 acts to rotate the reel 30 back to its initial position.

A flexible metallic tape 50, e.g., a steel tape, is wound in a roll shape on the outer circumference of the reel 30. The proximal end of the tape 50 is fixedly secured to the reel 30 and the distal or free end of the tape 50 is exposed through the opening 18 of the case 10. As the reel 30 turns in one direction, i.e., the forward direction, the tape 50 is unwound from the reel 30. In contrast, the tape 50 is rewound onto the reel 30 when the reel 30 turns in the other direction, i.e., the reverse direction. The tape 50 has measurement indicia or markings 52 arranged along its upper surface and used in length measurement.

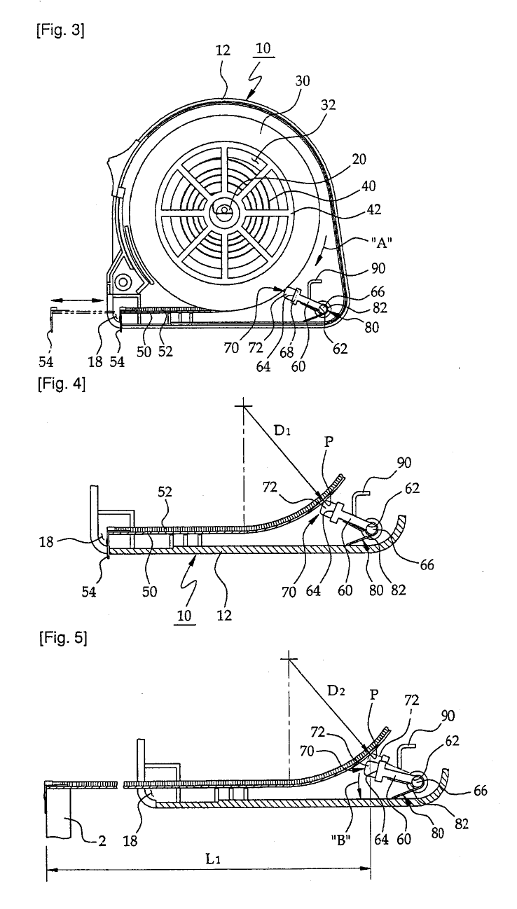

The tape 50 includes a hook 54 at its free end exposed through the opening 18 of the case 10. Thus the user can pull the hook 54 away from the case 10 in order to draw the tape 50 or can attach the hook 54 to the object 2 to be measured. As shown in FIGS. 3 and 4, when the tape 50 is in the initial position where the hook 54 abuts against the opening 18 of the case 10, it has a first diameter D1, i.e., a maximum diameter.

Referring to FIGS. 1 through 4, a pivot member 60 is pivotally mounted within the case 10 so that it can be rotated about one end 62 of the same. The other end 64 of the pivot member 60 is located adjacent the rear surface of the tape 50 wound on the reel 30 in the first diameter D1. The pivot member 60 is provided with a shaft 66 on its one end, and the shaft 66 is pivotably fitted to the axial holes 22a and 22b. The pivot member 60 has a recess 68 on the other end 64 thereof.

Coupled to the other end 64 of the pivot member 60 is a friction member 70 that makes contact with the tape 50 and applies a friction force thereto when the tape 50 is in the initial position. The friction member 70 includes a friction pad 72 fixedly engaged with the recess 68 of the pivot member 60. The friction pad 72 is designed to control the retracting movement and speed of the tape 50. In other words, the friction pad 72 makes contact with the tape 50 to apply a friction force thereto, thereby controlling the retracting movement and speed of the tape 50. The friction pad 72 may be attached to the other end 64 of the pivot member 60 through the use of an adhesive agent. The friction pad 72 may be made of an elastic material such as rubber, synthetic rubber, silicon rubber, urethane rubber or the like. As shown in FIGS. 3 and 4, the friction pad 72 makes contact with the rear surface of the tape 50 to apply a friction force thereto when the tape is in the initial position where the hook 54 abuts against the opening 18 of the case 10.

Referring again to FIGS. 1 through 4, it will be seen that a resilient member 80 is retained on the shaft 66 of the pivot member 60. The resilient member 80 is designed to rotate the pivot member 60 by an elastic restoration force thereof in such a direction as to bring the friction pad 70 into contact with the rear surface of the tape 50. The resilient member 80 may be a torsion spring 82, a compression coil spring or the like. One end of the torsion spring 82 abuts against the inside of the case 10, while the other end of the torsion spring 82 leans against the pivot member 60. Alternatively, one end of a compression coil spring may lean against one side of the pivot member 60 or the shaft 66, and the other end of the compression coil spring may abut against the inside of the case 10.

The tape measure in accordance with the first embodiment of the present invention further includes a stopper 90 arranged on an inner side of the case 10 as a restraint means for restraining the pivotal movement of the pivot member 60. The stopper 90 may be integrally formed with the case 10 which is manufactured by injection-molding a plastic material. The stopper 90 is arranged to make contact with the pivot member 60 when the tape 50 is in the initial position where the friction member 70 comes into close contact with the rear surface of the tape 50, thereby restraining the pivotal movement of the pivot member 60.

Referring back to FIGS. 1 and 2, the tape measure in accordance with the first embodiment of the present invention further includes a manipulating mechanism 100 for rotating the pivot member 60 in such a direction as to cause the friction member 70 to be separated from the tape 50. The manipulating mechanism 100 includes a handle 102 formed at one side of the pivot member 60, the handle 102 protruding out of the through hole 24 of the case 10. The user can turn the handle 102 of the pivot member 60 in such a direction that the other end 64 of the pivot member 60 is moved away from the tape 50. The handle 102 shown in FIGS. 1 and 2 is integrally formed with the shaft 66. However, the position of the handle 102 connected to the pivot member 60 may be changed properly depending on a design option.

Hereinafter, the operation of the tape measure in accordance with the first embodiment of the present invention will be described in detail.

Referring to FIGS. 3 and 5, the user may attach the hook 54 to the object 2 to be measured and then carry the case 10 by a certain distance straightly away from a location where the hook 54 is secured to the object 2. As the user keeps on moving together with the case 10, the tape 50 wound on the reel 30 is pulled out through the opening 18 of the case 10. As a result, the tape 50 is straightened under tension. At the same time, as depicted by arrow “A” in FIG. 3, the reel 30 turns in the forward direction, i.e., clockwise, by the pulling force of the tape 50, and the tape 50 is further drawn out of the opening 18 of the case 10 by a desired distance. The spiral spring 40 is slowly coiled clockwise and gradually compressed along with rotation of the reel 30, thereby storing elastic energy that will work as an elastic restoration force. The elastic restoration force accumulated in the spiral spring 40 is in proportion to the length of the tape 50 drawn out of the case 10.

Referring to FIG. 4, it will be appreciated that the first diameter D1 of the tape 50 is gradually decreased from its maximum value as the tape 50 continues to be unwound from the reel 30 from its initial position. The friction force between the tape 50 and the friction member 70 is also gradually reduced as the diameter of the tape 50 decreases from its first diameter D1. Accordingly, the tape 50 is unwound smoothly from the reel 30. When the tape 50 is unwound from the reel 30 from its initial position, torque is applied to the friction member 70 due to the friction force acting between the tape 50 and the friction member 70.

As indicated by arrow “B” in FIG. 5, the pivot member 60 rotates about the shaft 66 in the direction opposite to the rotational direction of the reel 30, i.e., counterclockwise, by the torque applied to the friction member 70. Accordingly, the friction force acting between the tape 50 and the friction member 70 decreases, and the tape 50 is thus smoothly unwound from the reel 30. The elastic restoration force of the torsion spring 82 is accumulated by the counterclockwise pivotal movement of the pivot member 60. While the tape 50 is extended to a first length L1 from the position “P” where the tape 50 begins to make contact with the friction member 70, it continues to make contact with the friction member 70 kept in the initial position as indicated in a double-dotted chain line in FIG. 5. At this time, the tape 50 is wound on the outer circumference of the reel 30 in a size greater than a second diameter D2.

As illustrated in FIG. 6, the tape 50 comes out of contact with the friction member 70 when the distal end of the tape 50 is drawn out into a length greater than the second length L2 from the position “P” where the tape 50 begins to make contact with the friction member 70. When the tape 50 is out of contact with the friction member 70, the tape 50 is wound on the outer circumference of the reel 30 in a size smaller than a third diameter D3. In case where the tape 50 is not in contact with the friction member 70, the pivot member 60 is rotated clockwise by the elastic restoration force of the torsion spring 82 as indicated by arrow “C” in FIG. 6, so that the pivot member 60 can be supported and held against movement by the stopper 90.

After measuring the length of the object 2, the hook is disengaged from the object 2. If the hook 54 is removed from the object 2, the spiral spring 40 is also released from its compressed state and is uncoiled counterclockwise by the elastic restoration force thereof. Along with the uncoiling operation of the spiral spring 40, the reel 30 turns counterclockwise so as to rewind the tape onto the outer circumference thereof. If the tape 50 comes out of contact with the friction member 70 during the rewinding operation, the retracting speed of the tape 50 may be further increased by the elastic restoration force of the spiral spring 40. As shown in FIG. 5, when the tape 50 is wound on the outer circumference of the reel 30 in the second diameter D2, the rear surface of the tape 50 makes contact with the friction member 70. The friction force is applied to the retracting tape 50 from the moment when the tape 50 begins to make contact with the friction member 70. Accordingly, the retracting speed of the tape 50 is quickly decreased to a certain level, which allows the rewinding operation of the tape 50 to be performed in a safe and precise manner. Further, the inventive tape measure can prevent the case 10 and/or the hook 54 from being damaged or deformed, which would often occur as the hook 54 collides with the case 10. Also, the tape measure can prevent the user from getting hurt even when the user accidentally touches the retracting tape 50 with his or her hand or fingers.

Referring to FIGS. 3 and 4, it can be seen that the friction force between the tape 50 and the friction member 70 increases as the diameter of the tape 50 wound on the reel 30 approaches the first diameter D1. If the friction force between the tape 50 and the friction member 70 is greater than the elastic restoration force of the spiral spring 40, the turning movement of the reel 30 is automatically stopped and thus the rewinding operation of the tape 50 is also paused momentarily. Such a state is referred to as self-locking herein.

Referring to FIGS. 1 and 5, when the tape 50 has been self-locked by the friction force of the friction member 70, the user revolves the handle 102 to rotate the pivot member counterclockwise in order to release the self-locking state of the tape 50. If the pivot member 60 is rotated counterclockwise as indicated by arrow “B” in FIG. 5, the friction member 70 comes out of contact with the rear surface of the tape 50. Upon separating the friction member from the tape 50, the reel 30 resumes to turn counterclockwise under the action of the elastic restoration force of the spiral spring 40, so that the tape 50 can be rewound on the outer circumference of the reel 30.

If the user releases the handle 102, the pivot member 60 is rotated clockwise by the elastic restoration force of the torsion spring 82 to bring the friction member 70 into contact with the rear surface of the tape 50. Accordingly, the friction force acting between the tape 50 and the friction member 70 increases to automatically stop again the turning movement of the reel 30 and the rewinding operation of the tape 50, resulting in another self-locking state of the tape 50. This makes it possible for the user to activate or release the self-locking state of the tape 50 with ease whenever such a need arises during the rewinding operation of the tape 50. Therefore, the rewinding operation of the tape 50 can be performed in a safe way.

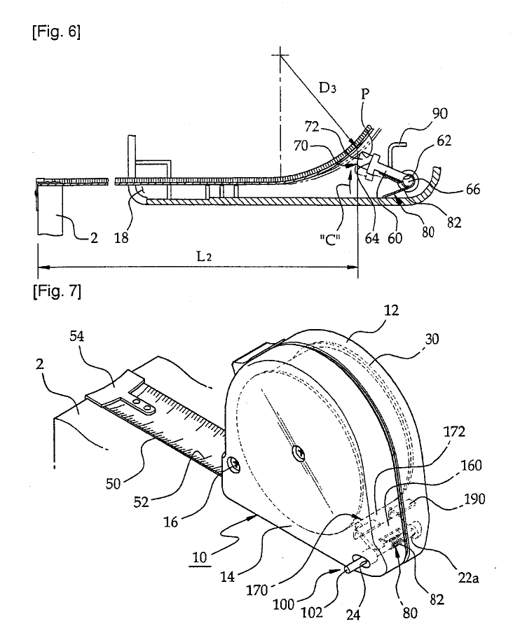

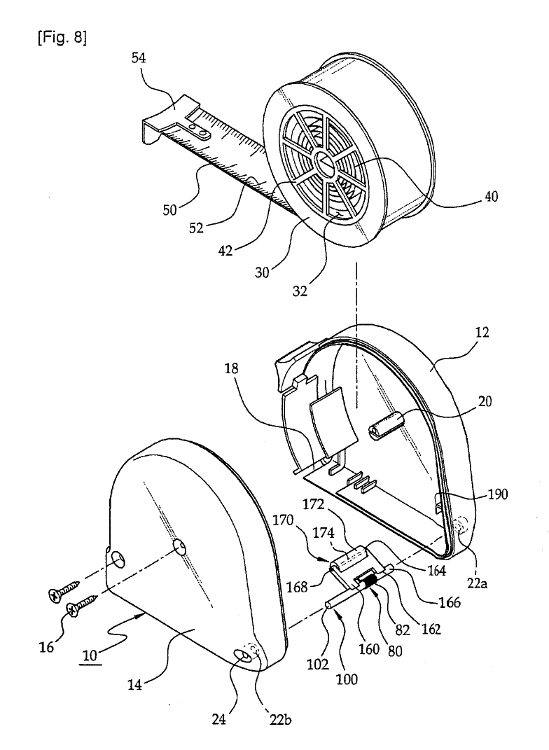

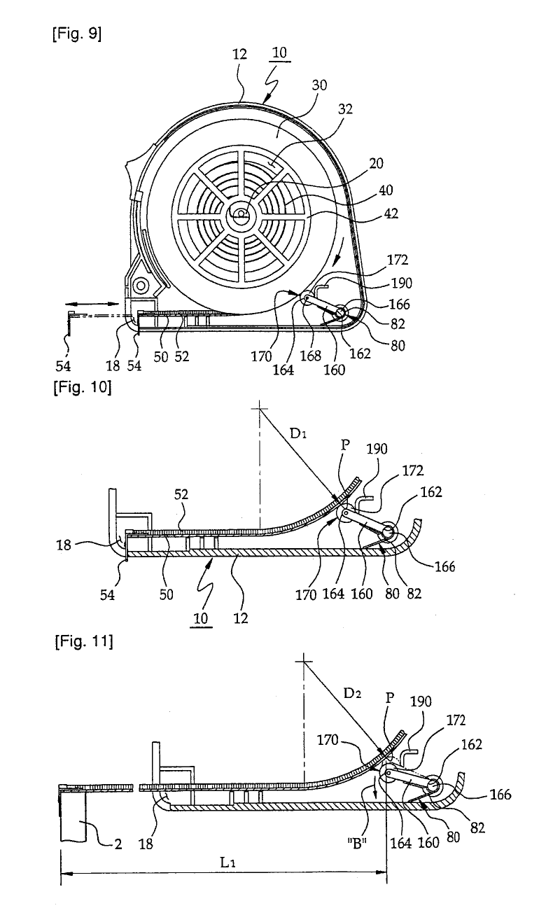

FIGS. 7 through 11 show a tape measure in accordance with a second embodiment of the present invention. Referring to FIGS. 7 through 11, a tape measure in accordance with the second embodiment of the present invention includes a case 10, a reel 30, a spiral spring 40, a tape 50, a pivot member 160, a friction member 170, a resilient member 80, a stopper 190 and a manipulating mechanism 100. The construction and operation of the case 10, the reel 30, the spiral spring 40, the tape 50, the resilient member 80 and the manipulating mechanism 100 is substantially the same as described above in connection with the first embodiment. Thus the same components will be designated by like reference numerals, with the detailed description thereof omitted.

A pivot member 160 of the tape measure in accordance with the second embodiment of the present invention is pivotally installed within the case 10 and capable of rotating about the end 162 of the latter. The other end 164 of the pivot member 160 is arranged to make contact with the rear surface of the tape 50 wound on the reel 30 in a first diameter D1. The pivot member 160 is provided with a shaft 166 at its one end, and the shaft 166 is pivotably engaged with the axial holes 22a and 22b. The pivot member 160 has an axial hole 168 at the other end 164 thereof.

A friction member 170 includes a friction roller 172 which is rotatably coupled to the other end 164 of the pivot member 160. The shaft 174 of the friction roller 172 is rotatably engaged with the axial hole 168 of the pivot member 160. The friction roller 172 is designed to control the rewinding operation of the tape 50 by making rolling contact with the rear surface of the tape 50 and applying a friction force to the tape 50. The friction roller 172 may be made of an elastic material such as rubber, synthetic rubber, silicon rubber, urethane rubber or the like. The friction roller 172 is adapted to rotate about the shaft 174 by making contact with the tape 50 during the unwinding or rewinding operation of the tape 50. The outer circumference of the friction roller 172 makes contact with the tape 50 at varying points as the friction roller 172 rotates. This assists in preventing reduction in the lifespan of the friction roller 172, which would otherwise be caused by the partial wear of the friction roller 172.

A stopper 190 is integrally formed with the case 10 which is injection-molded with a plastic material. The stopper 90 is adapted to make contact with the pivot member 60 when the tape 50 is in the initial position where the friction member 70 comes into close contact with the rear surface of the tape 50, thereby restraining the pivotal movement of the pivot member 60. Alternatively, the stopper 190 may be constructed to make contact with the pivot member 160.

Referring to FIG. 10, the friction roller 172 makes rolling contact with the rear surface of the tape 50 to apply a friction force thereto when the tape 50 is in the initial position where the hook 54 is engaged with the opening 18 of the case 10. The first diameter D1 of the tape 50 is gradually decreased from the maximum value as the tape 50 is unwound from the reel 30 in the initial position. Accordingly, the friction force acting between the tape 50 and the friction roller 172 is also gradually reduced as the diameter of the tape 50 decreases from the first diameter D1.

Referring to FIG. 11, when the tape 50 kept in the initial position is unwound from the reel 30, the friction force acting between the friction roller 172 and the tape 50 applies torque to the friction roller 172. As indicated by arrow “B” in FIG. 11, the pivot member 160 is rotated about the shaft 166 counterclockwise by the torque applied to the friction roller 172. Accordingly, the friction force acting between the tape 50 and the friction roller 172 decreases, and the tape 50 is smoothly unwound from the reel 30. While the tape 50 is extended a first length L1 from the position “P” where the tape 50 begins to make contact with the friction roller 172, the tape 50 continues to make contact with the friction member 70 kept in the initial position as shown in a double-dotted chain line in FIG. 11. The tape 50 is wound on the outer circumference of the reel 30 in a size equal to or greater than a second diameter D2.

As shown in FIG. 12, the tape 50 is not in contact with the friction roller 172 when the distal end of the tape 50 is drawn out a length equal to or greater than the second length L2 from the position “P” where the tape 50 begins to make contact with the friction roller 172. If the tape 50 comes out of contact with the friction roller 172, the tape 50 is wound on the outer circumference of the reel 30 in a size less than a third diameter D3. The tape 50 unwound a length equal to or greater than the second length L2 is rewound and is brought into contact with the friction roller 172 again due to the gradual increase of its diameter. As the tape 50 comes into contact with the friction roller 172 during the rewinding operation, the retracting speed of the tape 50 is gradually decreased by the frictional force acting between the tape 50 and the friction roller 172, eventually bringing the tape 50 into a self-locking state.

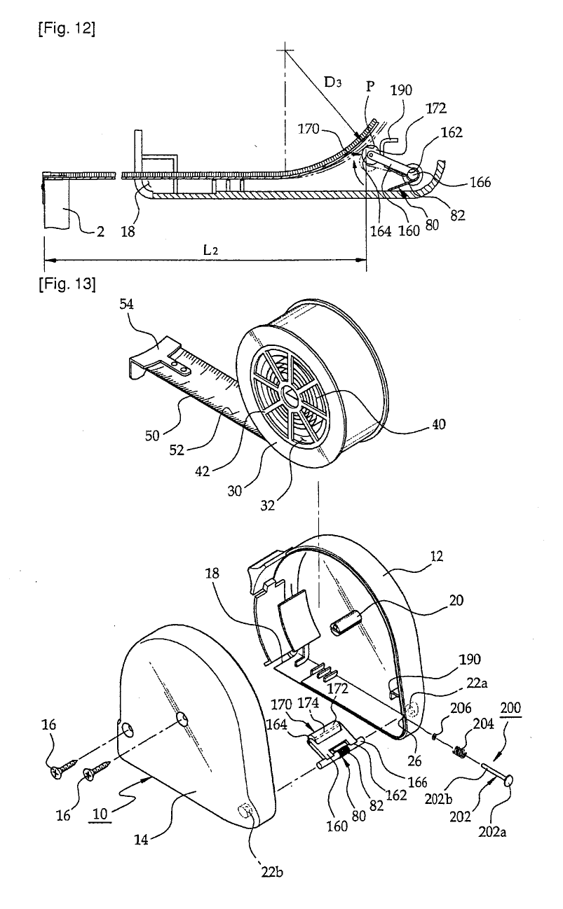

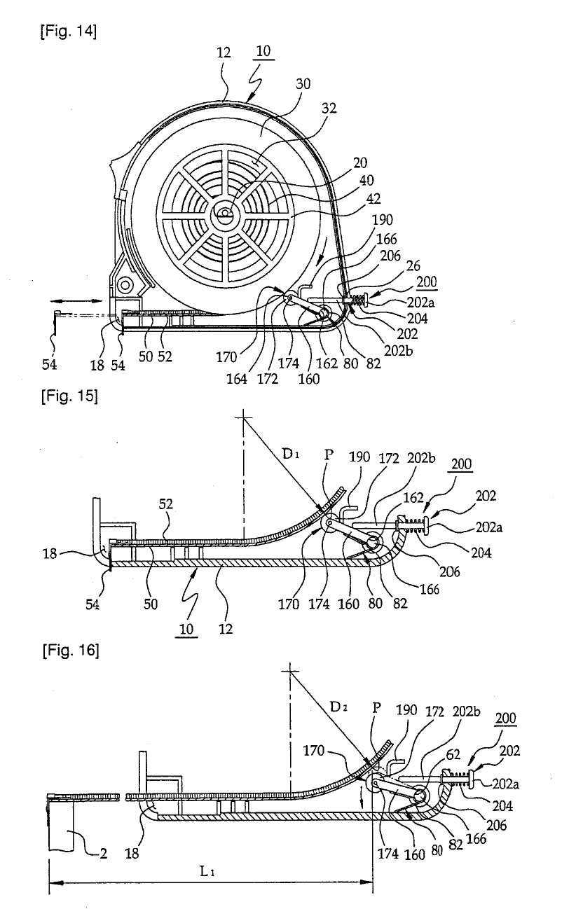

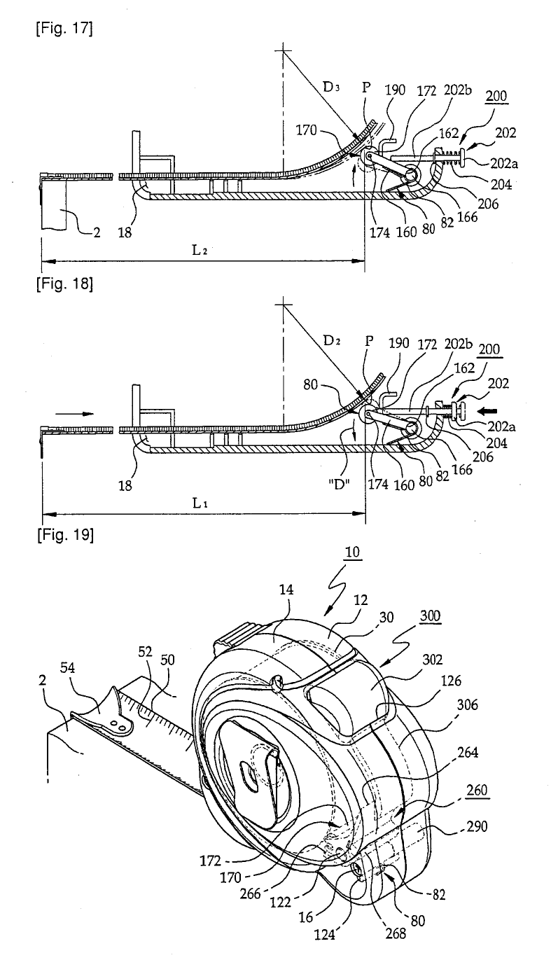

FIGS. 13 through 18 show a tape measure in accordance with a third embodiment of the present invention. Referring to FIGS. 13 through 18, the tape measure in accordance with the third embodiment of the present invention includes a case 10, a reel 30, a spiral spring 40, a tape 50, a pivot member 160, a friction member 170, a resilient member 80, a stopper 190 and a manipulating mechanism 200. The construction and operation of the case 10, the reel 30, the spiral spring 40, the tape 50, the pivot member 160, the friction member 170, the resilient member 80 and the stopper 190 is substantially the same as described in respect of the second embodiment. Thus the same components will be designated by like reference numerals, with the detailed description thereof omitted.

A hole 26 is provided on the opposite side of the case from the opening 18. The manipulating mechanism 200 includes a button 202, a spring 204 and a stopper 206. The button 202 includes a push portion 202a and a rod portion 202b. The push portion 202a is fully exposed to the outside of the case 10 through the hole 26 of the case 10 so that the user can manipulate the push portion 202a of the button 202. The rod portion 202b is operably connected to the push portion 202a to push and rotate the pivot member 160 in such a direction as to cause the friction member 170 to be separated from the tape 50. A spring 204 is arranged between the outer surface of the case 10 and the push portion 202a for applying a resilient force to the button 202 to return the same to its initial position. The spring 204 may include a compression coil spring. The stopper 206 is provided in the rod portion 202b of the button 202 which is positioned within the case 10. The stopper 206 makes contact with the inner surface of the case 10 to define the initial position of the button 202. In the alternative, the stopper 206 may be constructed from a snap ring.

Referring to FIG. 18, if the user presses the push portion 202a of the button 202 in a state that the tape 50 is self-locked by the friction force of the friction roller 172, the rod portion 202b pushes the pivot member 160 kept in its initial position and rotates the same in the direction indicated by arrow “D” in FIG. 18, i.e., counterclockwise. If the pivot member 160 is rotated counterclockwise, the friction roller 172 is separated from the rear surface of the tape 50 to release the frictional contact between the friction roller 172 and the tape 50. Upon separating the friction roller 172 from the tape 50, the reel 30 resumes to turn counterclockwise by the elastic restoration force of the spiral spring 40, so that the tape 50 can be rewound again onto the outer circumference of the reel 30. Thus the rewinding operation of the tape 50 can be performed in an easy and safe manner. If the user releases the pushing force applied to the push portion 202a, the button 202 is returned to its initial position by the elastic restoration force of the spring 204. Accordingly, the pivot member 160 is rotated clockwise by the elastic restoration force of the torsion spring 82 to bring the friction roller 172 into contact with the rear surface of the tape 50, resulting in another self-locking state of the tape 50.

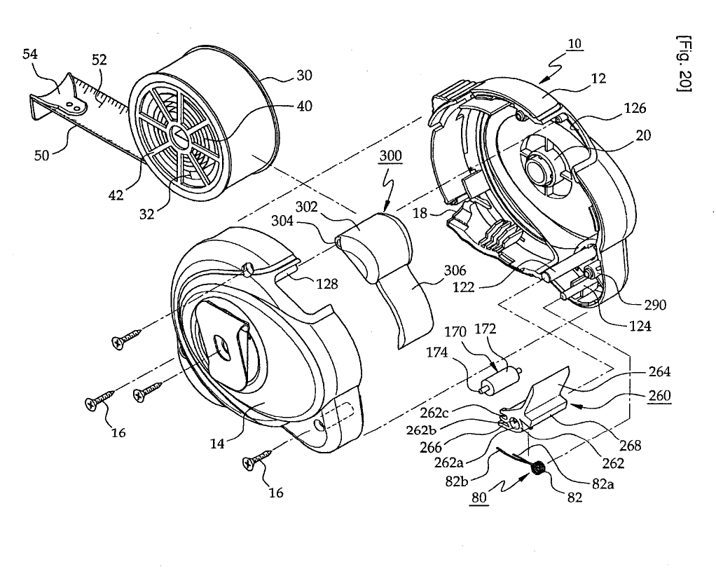

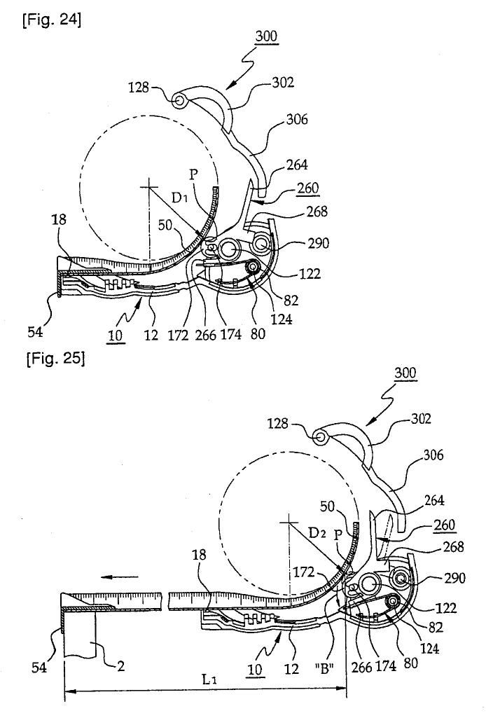

FIGS. 19 through 27 show a tape measure in accordance with a fourth embodiment of the present invention. Referring to FIGS. 19 through 27, the tape measure in accordance with the fourth embodiment of the present invention includes a case 10, a reel 30, a spiral spring 40, a tape 50, a pivot member 260, a friction member 170, a resilient member 80, a first restraint member, a second restraint member and a manipulating mechanism 300. The construction and operation of the case 10, the reel 30, the spiral spring 40, the tape 50, the resilient member 80, the friction member 170 and the resilient member 80 is substantially the same as described in connection with the third embodiment. Thus the same components will be designated by like reference numerals, with the detailed description thereof omitted.

The tape measure in accordance with the fourth embodiment of the present invention includes a reel 30, a spiral spring 40, a friction member 170 and a resilient member 80, all of which are arranged within a case 10. A shaft 122 is provided on the lower inner side of the case 10, and a pin 124 is formed adjacent the shaft 122. On the upper outer side of the case 10, there is provided an aperture 126 through which to expose the manipulating mechanism 300. A shaft 128 is provided on the inner side of the case 10 near the aperture 126. As shown in FIGS. 19 through 21, the aperture 126 is formed on the upper outer side of the case 10. However, the location of the aperture 126 may be properly changed depending on a design option.

Referring to FIGS. 19 through 23, a pivot member 260 is pivotally installed within the case 10 and capable of rotating about a shaft 122 provided in the case 10. The pivot member 260 includes a hub 262, a first arm 264, a second arm 266 and a lug 268. The hub 262 is provided with a axial hole 262a for receiving the shaft 122 formed within the case 10. A communication aperture 262b communicating with the axial hole 262a is formed on the outer surface of the hub 262. A pair of spaced-apart slots 262c and 262d are formed in the opposite end portions of the hub 262, with the communication aperture 262b interposed therebetween. Each of the slots 262c and 262d is opened toward the tape 50 at its one end to receive the friction member 170. The first arm 264 extends in the radial direction of the hub 262 on the upper outer surface of hub 262, while the second arm 266 extends in the tangential direction of the hub 262 on the lower outer surface of the hub 262. A pair of supporting protrusions 266a and 266b are spaced apart from each other on the outer surface of the second arm 266. A lug 268 is located near the hub 262 on the lower side of the first arm 264 and extends over the entire width of the first arm 264.

A friction roller 172, as a friction member that makes contact with the tape 50 to apply a friction force thereto, is rotatably and displaceably retained in the slots 262c and 262d of the pivot member 260. The friction roller 172 includes a pair of shafts 174 protruding at its opposite ends. The respective shafts 174 are inserted into the slots 262c and 262d so that they can rotate and linearly move within the slots 262c and 262d.

A resilient member 80 is retained on the pin 124 of the case 10. The resilient member 80 is designed to rotate the pivot member 60 with an elastic restoration force thereof in such a direction as to bring the friction roller 172 into contact with the rear surface of the tape 50. The resilient member 80 includes a torsion spring 82. One end 82a of the torsion spring 82 is hooked onto the inside of the case 10, while the other end 82b of the torsion spring 82 is fixedly coupled to the second arm 266 of the pivot member 60. That is, the other end 82b of the torsion spring 82 is fixedly inserted between the supporting protrusions 266a and 266b of the second arm 266 of the pivot member 60, thereby applying an elastic restoration force to the second arm 266.

The tape measure in accordance with the fourth embodiment of the present invention includes a first restraint means, i.e., a stopper 290, provided on the inner side of the case 10 for restraining the pivotal movement of the pivot member 260. The stopper 290 is integrally formed with the case 10 which is injection-molded with a plastic material. The stopper 290 is adapted to make contact with the lug 268 of the pivot member 260 when the tape is in an initial position where the friction member 70 makes close contact with the rear surface of the tape 50, thereby restraining the pivotal movement of the pivot member 260.

The second restraint means of the tape measure in accordance with the fourth embodiment of the present invention includes a shaft 122 formed on the inner side of the case 10. When the tape 50 is in the initial position of the tape 50 where the friction member 70 makes a contact with the rear surface of the tape 50, the outer surface of the friction roller 172 is partially inserted into the communication aperture 262b of the hub 262, at which time the friction roller 172 makes contact with the shaft 122. Such contact between the friction roller 172 and the shaft 122 restrains the pivotal movement of the friction roller 172. In the alternative, the second restraint means may include a stopper formed at the inner side of the case 10 and capable of abutting against the friction roller 172.

Referring to FIGS. 19 through 21 and FIG. 24, the tape measure in accordance with the fourth embodiment of the present invention further include a manipulating mechanism 300 for forcibly rotating the pivot member 260. The manipulating mechanism 300 is formed of a button 302. The button 302 is mounted to protrude to the outside of the case 10 through the aperture 126. The button 302 is provided with an axial hole 304 at its one end. A shaft 128 of the case 10 is rotatably mounted in the axial hole 304 of the button 302. A rod 306 extends from the other lower end of the button 302 so that it can push the second arm 266 of the pivot member 260.

Referring now to FIG. 25, it can be noted that torque is applied to the friction roller 172 due to the friction force generated as the tape 50 kept in the initial position is unwound from the reel 30. As indicated by arrow “B” in FIG. 25, the pivot member 260 is rotated about the shaft 122 in the direction opposite to the rotational direction of the reel 30, i.e., counterclockwise, by the torque applied to the friction roller 172. When the pivot member 260 rotates counterclockwise, the friction roller 172 is separated from the rear surface of the tape 50. Accordingly, the friction force acting between the tape 50 and the friction roller 172 70 decreases, and the tape 50 is freely and smoothly unwound from the reel 30.

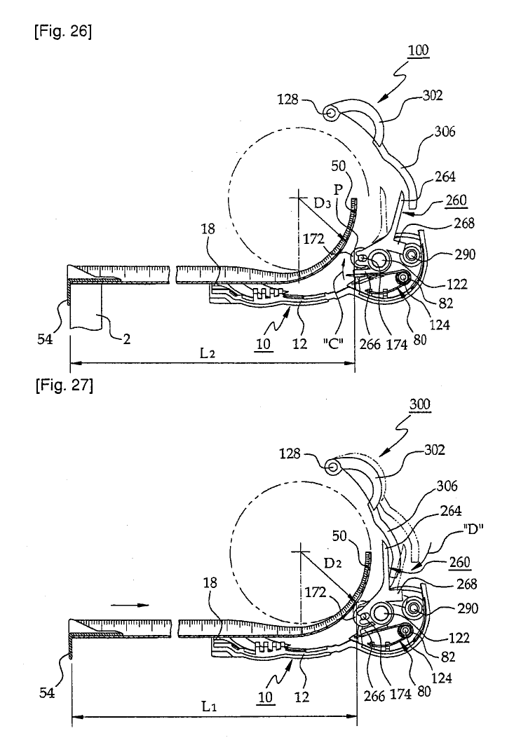

As illustrated in FIG. 26, the tape 50 comes out of contact with the friction roller 172 when the tape 50 is drawn out a length equal to or greater than the second length L2 and the remaining portion of the tape 50 wound on the outer circumference of the reel 30 has a third diameter D3. In case where the tape 50 does not contact with the friction roller 172, the pivot member 260 is rotated clockwise by the elastic restoration force of the torsion spring 82 as indicated by arrow “C” in FIG. 26. If the pivot member 260 rotates clockwise, the lug 268 is supported by the stopper 290 to restrain the pivotal movement of the pivot member 260.

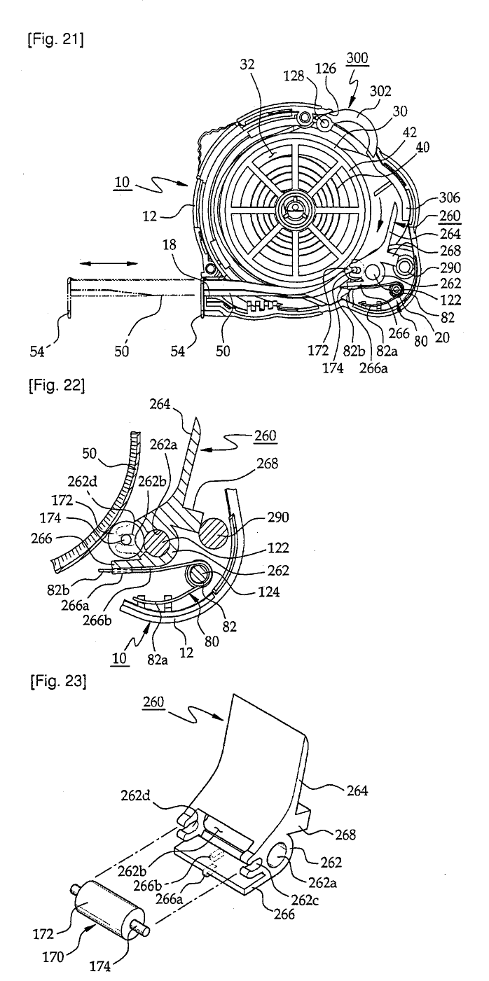

Referring to FIGS. 21, 22 and 24, it can be seen that the friction force acting between the tape 50 and the friction roller 172 becomes greater as the diameter of the tape 50 rewound approaches the first diameter D1. If the friction force is greater than the elastic restoration force of the spiral spring 40, the rotational movement of the reel 30 is stopped and thus the rewinding operation of the tape is also paused momentarily. As a result, the tape 50 comes into a self-locking state.

When the friction roller 172 comes into contact with the rear surface of the tape 50, the friction roller 172 moves into the communication aperture 262b and makes contact with the outer surface of the shaft 122, thereby restraining the pivotal movement of the friction roller 172. This prevents slip from occurring between the tape 50 and the friction roller 172, which enables the tape 50 to be stopped in a reliable manner. As the friction roller 172 and the tape 50 make contact with each other, the shafts 174 of the friction roller 172 are moved along the slots 262c and 262d, whereby the position of the friction roller 172 is adjusted to compensate the positional error between the friction roller 172 and the tape 50. Accordingly, the rewinding operation of the tape 50 is accurately controlled by the friction force of the friction roller 172.

Referring to FIG. 27, if the user presses the button 302 while the tape 50 is self-locked by the friction force of the friction roller 172, the button 302 is rotated about the shaft 128. The rod portion 306 of the button 302 pushes the first arm 264 of the pivot member 260. In response, the pivot member 260 is rotated counterclockwise as indicated by arrow “D” in FIG. 27. The counterclockwise rotation of the pivot member 260 ensures that the friction roller 172 comes out of contact with the tape 50 and is separated from the rear surface of tape 50. Upon separation of the friction roller 172 from the tape 50, the reel 30 resumes to rotate by the elastic restoration force of the spiral spring 40 so that the tape 50 is rewound onto the outer circumference of the rotating reel 30. Thus the rewinding operation of the tape 50 can be performed in an easy and safe manner.

If the user removes the pushing force from the button 302, the pivot member 260 is returned to its initial position by the elastic restoration force of the torsion spring 82, at which time the first arm 264 of the pivot member 260 pushes the rod 306. Then the button 302 is rotated about the shaft 128 and returned to its initial position.

The embodiments set forth hereinabove have been presented for illustrative purpose only and, therefore, the present invention is not limited to these embodiments. It will be understood by those skilled in the art that various changes and modifications may be made without departing from the scope of the invention defined in the claims.

### INDUSTRIAL APPLICABILITY

With the present tape measure described above, the retracting movement and speed of the tape can be controlled in a safe and accurate manner by applying a friction force to the tape rewound. It is also possible to easily release the friction force and to smoothly perform the unwinding operation of the tape. The safety in use is greatly improved by the self-locking operation with which the tape is automatically stopped during the rewinding operation. The stoppage of the tape during the rewinding operation can be released with ease, which assists in enhancing the convenience in use.

1. A tape measure, comprising:
a case having an opening at one side;
a reel rotatably mounted within the case, the reel having an outer circumference;
a spiral spring for elastically biasing the reel to rotate in a rewinding direction, the spiral spring having a first end fixedly secured to the case and a second end fixedly coupled to the reel;
a tape wound on the outer circumference of the reel, the tape having a proximal end fixedly secured to the outer circumference of the reel and a distal end exposed through of the opening of the case, the tape having a maximum winding diameter in a fully retracted initial position;
a pivot member pivotally mounted with the case;
a friction member carried by the pivot member for making contact with the tape to apply a friction force to the tape when the tape is in the initial position; and
a resilient member retained in the case for elastically biasing the pivot member to rotate in such a direction as to cause the friction member to make contact with the tape.

2. The tape measure as recited in claim 1, wherein the friction member comprises a friction pad fixed to the pivot member.

3. The tape measure as recited in claim 1, wherein the friction member includes a friction roller rotatably mounted to the pivot member.

4. The tape measure as recited in claim 1, further comprising a restraint means for restraining the movement of the pivot member when the tape is in the initial position where the friction member makes contact with the tape.

5. The tape measure as recited in claim 4, wherein the restraint means comprises a stopper provided within the case for making contact with the pivot member when the tape is in the initial position.

6. The tape measure as recited in claim 4, wherein the restraint means comprises a stopper provided within the case for making contact with the friction member when the tape is in the initial position.

7. The tape measure as recited in claim 3, further comprising a restraint means provided within the case for restraining the rotation of the friction roller when the friction roller makes contact with the tape.

8. The tape measure as recited in claim 7, wherein the pivot member includes a hub having an axial hole and a communication aperture formed along the hub to communicate with the axial hole, the friction roller being partially received within the communication hole, and wherein the restraint means comprises a shaft fitted to the axial hole so that the friction roller can make contact with the shaft.

9. The tape measure as recited in claim 8, wherein the hub has a pair of spaced-apart slots opened toward the tape and wherein the friction roller is provided at its opposite ends with a pair of shafts, the shafts being rotatably and displaceably inserted into the slots.

10. The tape measure as recited in claim 1, wherein the resilient member comprises a torsion spring having a first end fixedly secured to the case and a second end coupled to the pivot member.

11. The tape measure as recited in claim 1, further comprising a manipulating means for pressing and rotating the pivot member to have the friction member move away from the tape.

12. The tape measure as recited in claim 11, wherein the manipulating means comprises:
a button including a push portion arranged outside the case and a rod portion connected to the push portion, the rod portion extending into the case so that the pivot member can be pushed by the rod portion; and
a spring installed between the case and the push portion for resiliently biasing the button to move away from the pivot member.

13. The tape measure as recited in claim 11, wherein the manipulating means comprises a button rotatably mounted to the case, the button having a rod for pushing the pivot member.
